(19) United States
(12) Patent Application Publication
(10) Pub. No.: US 2013/0004675 A1
(43) Pub. Date: Jan. 3, 2013

(54) Method of powder coating plastic substrates

(75) Inventors: Mark P. Birka, Northville, MI (US); Steven J. Mori, Aurora (CA); Stephen B. Putman, Eden Mills (CA); David A. Detzler, Shelby Township, MI (US)

(73) Assignee: Magna International Inc., Aurora (CA)

(21) Appl. No.: 13/135,304

(22) Filed: Jun. 30, 2011

(51) Int. Cl. B05D 1/36

(52) U.S. Cl. 427/470

(57) ABSTRACT

A method for powder coating plastic substrate. The substrate in one embodiment is a formed part for a vehicle made from a polypropylene base, polyolefins or acrylonitrile butadiene styrene. The method also further involves providing a conductive adhesion promoter, such as a chlorinated polyolefin that includes a conductive carbon black filler. A powder coat material is applied at a later step and then is melted onto the substrate creating a finished part having a high quality finish.

### FIELD OF THE INVENTION

The present invention relates to a method for powder coating plastic substrate parts using a conductive adhesion promoter.

### BACKGROUND OF THE INVENTION

In the automotive industry, as well as other manufacturing related industries, there is often a need to replace existing materials to reduce cost, environmental impact of production methods and part production time. With regard to automotive components, exterior and interior parts have typically been wet painted, creating serious environmental concerns due to the use of wet paint and the substantial cost of equipment and paint to provide a suitable finish on the painted part. There is a growing need to eliminate partially or wholly all use of wet paint on automotive parts and replace it with a system that is more environmentally friendly as well as cost and time efficient.

### SUMMARY OF THE INVENTION

The present invention is directed to a method for powder coating plastic substrate. The substrate in one embodiment is a formed part for a vehicle made from a polypropylene base, polyolefins or acrylonitrile butadiene styrene. The method also further involves providing a conductive adhesion promoter, such as a chlorinated polyolefin that includes a conductive carbon black filler. However, it is also within the scope of the invention for other adhesion promoters to be used provided they have suitable conductive properties. The method also provides a powder coat material which can be a powder clear coat material, a powder base material, or a powder primer material.

The steps of the method include cleaning the substrate to remove contaminants and subsequently drying the substrate. Next, the conductive adhesion promoter is applied to the surface of the substrate, followed by the step of applying a layer of liquid basecoat to the substrate using a sprayer. The next step involves electro-statically applying the powder coat material to form a powder coat layer on the substrate with the adhesion promoter and the liquid basecoat. Lastly, the step of heating the substrate with the adhesion promoter, liquid basecoat layer and powder coat layer occurs in order to bring the substrate and various layers of material to a temperature suitable to melt the powder coat layer and cross-link the adhesion promoter with the powder coat layer and the substrate. The steps of applying the conductive adhesion promoter, applying the layer of liquid basecoat and applying the powder coat material to the substrate all occur at ambient room temperatures in the absence of a heat source for applying heat to the part.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of the method for powder coating plastic substrate parts in accordance with one embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

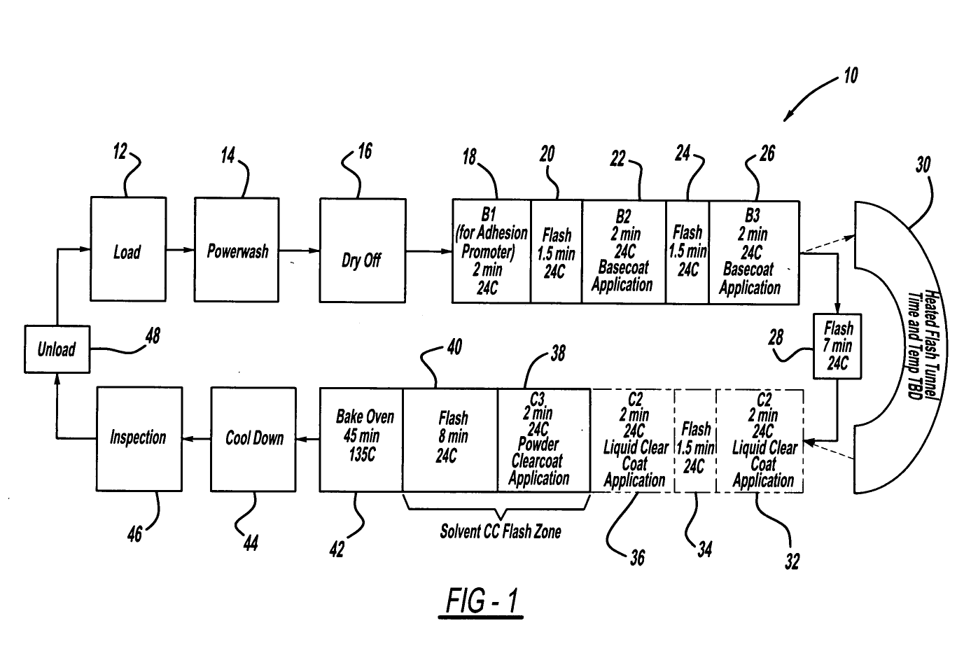

FIG. 1 is a schematic view of a method for powder coating plastic substrate parts in accordance with one embodiment of the present invention. The method shown in FIG. 1 is used for describing a method of applying powder clear coat material to a substrate, which in one embodiment of the invention is a part for a vehicle. However, it is within the scope of this invention for the method to be used for applying powder clear coats, powder basecoats or both to automotive vehicle components. Additionally, the method is used for automotive vehicle components that are exterior components, interior components or non-automotive applications such as marine, aviation, railroad, appliances or construction industries where parts are painted on a paint line. The method of powder coating is generally shown in FIG. 1. The method begins at a step 12 wherein a substrate is loaded onto the paint line 10. The paint line is a conveyor system that moves parts between stations. The substrate, as described above, is a part for a vehicle, and is generally formed from plastic material. In one embodiment of the invention, the substrate is made of one material selected from the group comprising polypropylene, polyolefin and acrylonitrile butadiene styrene. However, it is within the scope of this invention for other polymer materials to be used in forming the substrate.

At a step 14, the substrate is washed with a cleaning solution to remove unwanted dirt or contaminants on the surface of the substrate and then at a step 16 the substrate is dried using either heat or filtered air blown onto the substrate to dry off the substrate prior to further steps. It is also within the scope of this invention to heat the substrate in an oven and then allow the substrate to cool.

At a step 18, a conductive adhesion promoter material is sprayed onto the surface of the substrate. Prior to beginning the step 18 of applying the conductive adhesion promoter, the part temperature may range from 24° C. to 38° C. as a result of heat inducted onto the substrate during the steps 14, 16. The conductive adhesion promoter contains a chlorinated polyolefin and conductive carbon black solid filler material suspended in a suitable solution that is sprayed onto the surface of the substrate at the step 18. At a step 20, the substrate with the layer of conductive adhesion promoter applied is allowed to dry for 1.5 minutes. The step of drying can be carried out using filtered air blown onto the substrate, heating the substrate and layer of adhesion promoter to cause evaporation of the liquid portions of the solution or by simply allowing the substrate with the conductive adhesion promoter layer to sit at ambient temperatures for a suitable period of time to allow evaporation of liquid from the surface of the substrate.

At a step 22, a liquid basecoat layer is applied to the substrate using a sprayer. The liquid basecoat in one embodiment is liquid paint. However, it is within the scope of this invention for the liquid basecoat to be substituted with a powder basecoat similar the powder clear coat material that will be described at a later step. Once the step 22 of applying the liquid basecoat layer is completed at a step 24, the substrate with the layer of adhesion promoter and the layer of liquid basecoat is allowed to flash dry for 1.5 minutes. This step 24 of flash drying can be carried out using filtered air blown onto the substrate, heating the substrate with layers of adhesion promoter and liquid basecoat to cause flash drying of the layers of liquid basecoat or allowing the substrate with the layer of conductive adhesion promoter and layers of liquid basecoat to sit at ambient temperatures for a suitable period of time to allow evaporation of liquid from the surface of the substrate.

At a step 26 a second layer or application of liquid basecoat is applied to the substrate. The liquid basecoat at a step 26 can be substituted with a powder basecoat material similar to the powder clear coat material described at a later step. The step 26 of applying the second application of liquid basecoat occurs in order to ensure that the substrate has been sufficiently painted. The application of the second liquid basecoat layer at the step 26 is optional since it is possible for only a single application to be necessary.

At a step 28, the substrate with the adhesion promoter layer and liquid basecoat layers, is allowed to flash dry for seven minutes at ambient temperature. This step of flash drying can be carried out using filtered air blown onto the substrate, heating the substrate with layers of adhesion promoter and liquid basecoat to cause flash drying of the layers of liquid basecoat or allowing the substrate with the layer of conductive adhesion promoter and layers of liquid basecoat to sit at ambient temperatures for a suitable period of time to allow evaporation of liquid from the surface of the substrate.

Step 30 is an alternate step to the step 28 wherein the substrate passes through a heated flash tunnel for a predetermined time or temperature. In certain applications, it may be necessary to carry out this step in order to sufficiently dry the substrate before applying the clear coat layers in the subsequent steps.

Steps 32, 34, 36 are optional steps wherein a particular application may require the application of a liquid clear coat material in addition to or without the application of a powder clear coat material. At step 32 a layer of liquid clear coat is applied to the surface of the substrate at ambient temperature. At step 34, the substrate with the newly sprayed layer of liquid clear coat is flash dried for 1.5 minutes. The flash drying can be carried out using filtered air blown onto the substrate, heating the substrate and layer of liquid clear coat to cause evaporation of liquid portions of the clear coat or by simply allowing the substrate with the liquid clear coat layer to sit at ambient temperatures for a suitable period of time to allow evaporation and drying of liquid clear coat layer. At step 36, a second liquid clear coat layer is applied. The application of a second liquid clear coat layer at step 36 is optional since it may be suitable for the single liquid clear coat layer applied at step 32 to provide sufficient coverage of the substrate.

If the above optional steps 32, 34, 36 are carried out or omitted, the substrate is then moved to a step 38 where a powder clear coat layer is applied to the surface of the part that were not liquid clear coat. The powder clear coat material is applied to the substrate using an electro-static sprayer that applies an electro-static charge to the powder clear coat material as the powder clear coat material leaves the sprayer. The powder clear coat material includes one selected from the group comprising acrylic polymers and cross-linked polymers; however, it is suitable for other types of polymers to be used. Additionally, the electro-static powder clear coat material may not necessarily be a clear coat material, but could also be a basecoat or paint coat material that could be substituted for the liquid basecoat material applied in steps 22 and 26.

After step 38, the substrate with all the layers is flash dried at step 40 for approximately eight minutes. Depending on the types of materials used, the period of time for drying can be longer than eight minutes. Additionally, the flash drying step 40 is carried out using filtered air blown onto the substrate, heating the substrate with the layer of powder clear coat and/or liquid clear coat to dry the layers or by simply allowing the liquid clear coat and powder clear coat layers to sit at ambient temperatures for a suitable period of time to allow evaporation and drying of the layers. At step 42, the substrate with all the layers enters a bake oven set at a temperature of at least 135° C. wherein the substrate is heated to a temperature of at least 121° C. for a period of time. The period of time is generally forty-five minutes; however, a lesser or greater amount of time as well as a lesser or greater temperature may be necessary depending on the types of materials and a type of substrate being used with the method. Additionally, the temperature of the bake oven and the time for step 42 must be suitable for the substrate with the adhesion promoter and the basecoat layer and powder clear coat or liquid clear coat layers to melt the powder clear layer and cross-link the adhesion promoter with the powder clear coat layer and the substrate.

At the step 44, the substrate is allowed to cool down to ambient temperatures and then at step 46, the substrate is inspected to make sure the appearance is suitable. Finally, at step 48, the finished substrate is unloaded from the paint line 10.

At all of the steps 20, 24, 28, 30, 24, 40 and 42 the temperature and drying time can vary depending on factors including temperature, materials used, size of the part and the number of layers applied to the substrate.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for powder coating plastic substrate comprising the steps of:
providing a substrate, a conductive adhesion promoter, and a powder clear coat material;
cleaning said substrate to remove contaminants;
applying the conductive adhesion promoter;
applying a layer of liquid basecoat to said substrate using a sprayer;
electro-statically applying said powder coat material to form a powder coat layer on said substrate with said adhesive promoter and said base coat; and
heating said substrate with said adhesion promoter, said basecoat layer and said powder coat layer applied.

2. The method of claim 1 wherein said substrate is a formed part for a vehicle.

3. The method of claim 2 wherein said formed part is made of one of the materials selected from the group comprising polypropylene, polyolefin and acrylonitrile butadiene styrene.

4. The method of claim 1 wherein said conductive adhesion promoter is a chlorinated polyolefin.

5. The method of claim 4 wherein said chlorinated polyolefin further includes a conductive carbon black filler.

6. The method of claim 1 wherein said powder clear coat material is one selected from the group comprising acrylic polymers and cross-linked polymers.

7. The method of claim 1 wherein said step of electro-statically applying the powder coat layer further includes an electro-static sprayer that applies an electro-static charge to said powder clear coat material as said powder coat layer is applied to said substrate.

8. The method of claim 1 wherein said step of applying said steps of applying said conductive adhesion promoter, said step of applying a layer of liquid basecoat and said step of electro-statically applying a powder coat layer are all carried out at ambient temperatures.

9. The method of claim 1 wherein said step of heating said substrate with said adhesion promoter and said basecoat layer and said powder coat layer further includes heating to a temperature to at least 121° C.

10. The method of claim 1 wherein said step of heating said substrate with said adhesion promoter and said basecoat layer and said powder coat layer further includes heating a temperature to a temperature suitable to melt said powder coat layer and cross-link said adhesion promoter with said powder coat layer and said substrate.

11. The method of claim 1 further comprising the step of drying said substrate with said adhesion promoter and said basecoat layer in a heated flash tunnel prior to said step of electro-statically applying a powder coat layer.

12. A method for powder coating plastic substrate comprising the steps of:
providing a substrate that is a formed part made of one of the materials selected from the group comprising polypropylene, polyolefin and acrylonitrile butadiene styrene;
providing a conductive adhesion promoter containing a chlorinated polyolefin and conductive carbon black filler;
providing a powder clear coat material, wherein said powder clear coat material is one selected from the group comprising acrylic polymers and cross-linked polymers;
cleaning said substrate to remove contaminants;
drying said substrate;
applying the conductive adhesion promoter to the substrate;
applying a layer of liquid base coat to said substrate using a sprayer;
electro-statically applying said powder coat material to form a powder coat layer on said substrate with said adhesive promoter and said basecoat; and
heating said substrate with said adhesion promoter, said liquid basecoat layer and said powder coat later applied.

13. The method of claim 12 wherein said substrate is a formed part for a vehicle.

14. The method of claim 12 wherein said step of electro-statically applying the powder coat layer further includes an electro-static sprayer that applies an electro-static charge to said powder clear coat material as said powder coat layer is applied to said substrate.

15. The method of claim 12 wherein said step of applying said steps of applying said conductive adhesion promoter, said step of applying a layer of liquid basecoat and said step of electro-statically applying a powder coat layer are all carried out at ambient temperatures.

16. The method of claim 12 wherein said step of heating said substrate with said adhesion promoter and said basecoat layer and said powder coat layer further includes heating to a temperature of at least 121° C.

17. The method of claim 12 wherein said step of heating said substrate with said adhesion promoter and said basecoat layer and said powder coat layer further includes heating a temperature to a temperature suitable to melt said powder coat layer and cross-link said adhesion promoter with said powder coat layer and said substrate.

18. The method of claim 12 further comprising the step of drying said substrate with said adhesion promoter and said basecoat layer in a heated flash tunnel prior to said step of electro-statically applying a powder coat layer.

19. A method for powder coating plastic substrate comprising the steps of:
providing a substrate, a conductive adhesion promoter and a powder clear coat material;
performing the following steps at ambient temperatures in the absence of a heat source:
cleaning said substrate to remove contaminant;
applying the conductive adhesion promoter;
applying a layer of liquid basecoat to said substrate using a sprayer;
electro-statically applying said powder coat material to form a powder coat layer on said substrate with said adhesive promoter and said basecoat;
performing the following step to a temperature of at least 121° C.:
drying said substrate in an oven.

20. The method of claim 19 wherein said substrate is a formed part for a vehicle.

21. The method of claim 19 wherein said formed part is made of one of the materials selected from the group comprising polypropylene, polyolefin and acrylonitrile butadiene styrene.

22. The method of claim 19 wherein said conductive adhesion promoter is a chlorinated polyolefin.

23. The method of claim 19 wherein said chlorinated polyolefin further includes a conductive carbon black filler.

24. The method of claim 19 wherein said powder clear coat material is one selected from the group comprising acrylic polymers and cross-linked polymers.

25. The method of claim 19 wherein said step of electro-statically applying the powder coat layer further includes an electro-static sprayer that applies an electro-static charge to said powder clear coat material as said powder coat layer is applied to said substrate.

26. The method of claim 19 wherein said step of heating said substrate with said adhesion promoter and said basecoat layer and said powder coat layer further includes heating a temperature to a temperature suitable to melt said powder coat layer and cross-link said adhesion promoter with said powder coat layer and said substrate.

27. The method of claim 19 further comprising the step of drying said substrate with said adhesion promoter and said basecoat layer in a heated flash tunnel prior to said step of electro-statically applying a powder coat layer.
